(19) United States
(12) Patent Application Publication
(10) Pub. No.: US 2015/0029381 A1
(43) Pub. Date: Jan. 29, 2015

(54) ELECTRONIC DEVICE AND METHOD OF PHOTOGRAPHING IMAGE USING THE SAME

(71) Applicants: Samsung Electronics Co., Ltd., Gyeonggi-do (KR); Industry-Academia Cooperation Group of Sejong University, Seoul (KR)

(72) Inventors: Myungsu KANG, Seoul (KR); Jihea PARK, Seoul (KR); Youngkeun CHOI, Gyeonggi-do (KR)

(73) Assignee: Samsung Electronics Co., Ltd.

(21) Appl. No.: 14/445,740

(22) Filed: Jul. 29, 2014

(30) Foreign Application Priority Data
Jul. 29, 2013 (KR) 10-2013-0089623

(51) Int. Cl. H04N 5/232; H04N 5/225

(52) U.S. Cl. CPC H04N 5/23216; H04N 5/2251; H04N 5/23293
USPC 348/333.01

(57) ABSTRACT

A method of photographing an image using an electronic device including a camera module is disclosed. The method includes receiving, at the electronic device, one or more pieces of guide information; determining whether to execute a guide function when driving the camera module; displaying the one or more pieces of guide information when the guide function is executed; displaying an external background obtained through the camera module in a preview screen form according to selected guide information; and obtaining an image according to the selected guide information.

### PRIORITY

This application claims priority under 35 U.S.C. §119(a) to Korean Patent Application No. 10-2013-0089623, which was filed in the Korean Intellectual Property Office on Jul. 29, 2013, the entire disclosure of which is hereby incorporated herein by reference.

### BACKGROUND OF THE INVENTION

1. Field of the Invention

The present invention relates generally to an electronic device and method of using the same, and more particularly, to an electronic device and method which uses guiding image photographing including a user guiding function.

2. Description of the Related Art

An electronic device for processing an image, such as a digital camera, or a device including a camera function, provides a photographing guide by controlling color information of a subject in real time or recognizing an object included in a photographed image to perform post-processing on the object.

However, such a post-processing method cannot provide a sufficient guide for photographing an optimal picture by a user in real time. In addition, when the user uses the post-processing method of an electronic device, the user only practices the art of taking and processing photographs by an image already photographed or the post-processed image. This may make it difficult to the user to analyze the image in real time and to practice photography.

### SUMMARY OF THE INVENTION

The present invention has been made to address at least the problems and/or disadvantages described above and to provide at least the advantages described below.

Accordingly, the present invention provides an electronic device and an image photographing method of the electronic device in which various pieces of guide information are provided to the user in real time.

In accordance with an aspect of the present invention, a method of photographing an image using an electronic device including a camera module is provided. The method includes receiving, at the electronic device, one or more pieces of guide information; determining whether to execute a guide function when driving the camera module; displaying the one or more pieces of guide information when the guide function is executed; displaying an external background obtained through the camera module in a preview screen form according to selected guide information; and obtaining an image according to the selected guide information.

In accordance with another aspect of the present invention, a method of photographing an image using an electronic device including a camera module is provided. The method includes receiving, at the electronic device, one or more pieces of guide information; determining whether to execute a guide function when driving the camera module; analyzing an image obtained through the camera module when the guide function is executed; calculating guide information mapped with the analyzed image among the one or more pieces of guide information; and obtaining an image through the camera module according to the calculated guide information.

In accordance with another aspect of the present invention, an electronic device is provided. The electronic device includes a communication unit for transmitting/receiving one or more pieces of guide information to/from a particular server or anther electronic device; a storage unit for storing the received one or more pieces of guide information; a touch screen for displaying the one or more pieces of guide information and an external background through a preview screen; a controller for determining whether to execute a guide function, displaying the one or more pieces of guide information on the touch screen when the guide function is executed, and displaying the external background on the touch screen through the preview screen according to selected guide information; and a camera module obtaining an image according to the selected guide information.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating a configuration of an electronic device, according to an embodiment of the present invention;

FIG. 2 is a flowchart illustrating an image photographing method of the electronic device, according to an embodiment of the present invention;

FIG. 3 is a flowchart illustrating an image photographing method of the electronic device, according to another embodiment of the present invention;

FIGS. 4-6 are diagrams illustrating an image photographing method using the electronic device, according to an embodiment of the present invention;

FIGS. 7-8 are diagrams illustrating an image photographing method using the electronic device, according to another embodiment of the present invention; and

FIG. 9 is a diagram illustrating an image method for providing a function related to photography training using the electronic device according to an embodiment of the present invention.

### DETAILED DESCRIPTION OF EMBODIMENTS OF THE PRESENT INVENTION

Hereinafter, embodiments of the present invention will be described with reference to the accompanying drawings to describe the present invention in detail so that the technical idea of the present invention can be easily implemented by those skilled in the art.

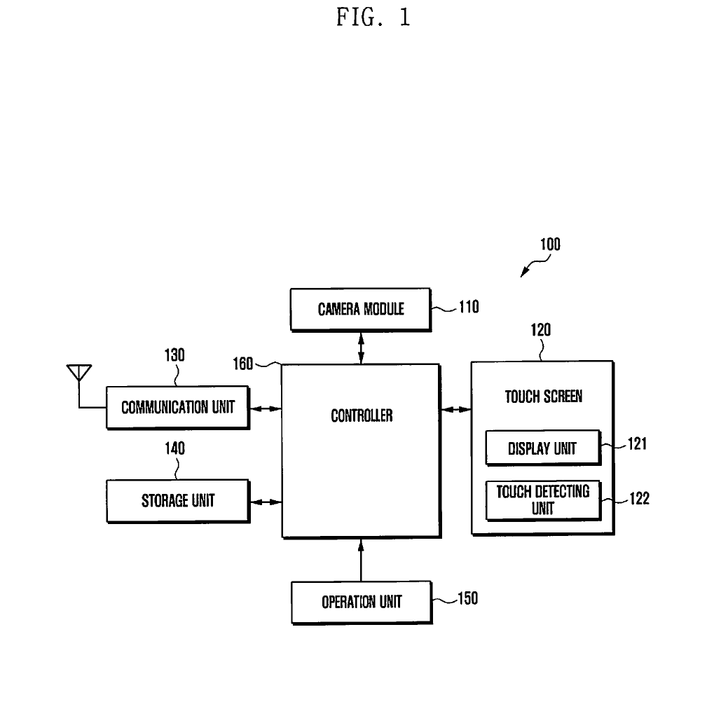

FIG. 1 is a block diagram illustrating a configuration of an electronic device 100 according to an embodiment of the present invention. The electronic device 100 includes a camera module 110, a touch screen 120, a communication unit 130, a storage unit 140, an operation unit 150, and a controller 160.

The camera module 110 may include a lens for concentrating light of an optical signal, an aperture for controlling a light amount of an optical signal, a shutter for controlling an input of an optical signal, and an image sensor (not shown) for receiving light of an optical signal and converting the optical signal to an electrical signal. For example, the lens may include a zoom lens for controlling a viewing angle to be narrower or wider according to a focal length and a focus lens focusing a camera on a subject. The lens may include one lens or a group of a plurality of lenses. According to an embodiment of the present invention, the shutter may include a mechanical shutter moving a cover upward or downward. According to another embodiment of the present invention, the image sensor may control supply of an electrical signal to perform a function of the shutter.

The camera module 110 may include a motor for driving the lens, the aperture, and the shutter. For example, the motor may control a position of the lens, opening and shutting of the aperture, and an operation of the shutter to execute functions, such as an auto focus, an automatic exposure control, an aperture control, a zoom, and a focus change. The motor may receive a control signal from the controller 160 and control driving of the lens, the aperture, and the shutter.

The image sensor receives an optical signal, converts the optical signal to an electrical signal, and transmits the electrical signal to the controller 160. The image sensor may include, for example, a Charge Coupled Device (CCD) sensor, a Complementary Metal Oxide Semiconductor (CMOS) sensor and the like. The controller 160 digitally-converts an electrical signal input from the camera module 110 to generate a digital signal. Further, the controller 160 may perform functions, such as a gain control, noise reduction processing, waveform shaping and the like, on an electronic signal provided from the camera module 110.

The touch screen 120 is an input/output means for simultaneously performing an input function and a display function and includes a display unit 121 and a touch detecting unit 122. The touch screen 120 displays various screens (e.g., a media content reproduction screen, a screen for an outgoing call, a messenger screen, a game screen, a gallery screen and the like) according to operations of a user device through the display unit 121. Further, when a touch event by the user is input into the touch detecting unit 122, while the screen is displayed on the display unit 121, the touch screen 120 transmits an input signal according to the touch event to the controller 160. Then, the controller 160 distinguishes the touch event and controls an operation according to the touch event.

The display unit 121 displays (e.g., outputs) information processed by the user device. For example, when the user device is in a call mode, the display unit 131 displays a call related User Interface (UI) or Graphical User Interface (GUI). Further, the display unit 121 displays a video call mode, a photographed or/and received image, or a UI or GUI. The display unit 121 supports a screen display in a landscape or portrait mode depending on a rotation direction of the user device (or a direction in which the user device is placed) and a screen switching display according to an orientation change between the landscape and portrait modes.

The display unit 121 may include at least one of a Liquid Crystal Display (LCD), a Thin Film Transistor-LCD (TFT-LCD), a Light Emitting Diode (LED), an Organic LED (OLED), an Active Matrix OLED (AMOLED), a flexible display, a bended display, and a 3D display. Some of the displays may be implemented as a transparent display configured in a transparent or photo-transparent type such that the outside can be viewed therethrough.

The touch detecting unit 122 may be positioned on the display unit 121 and may detect a user's touch event input (e.g., a touch based long press input, a touch based short press input, a single-touch based input, a multi-touch based input, a touch based gesture (e.g., a drag) input, or the like) contacting a surface of the touch screen 120. When the touch detecting unit 122 detects a touch event on the touch screen 120 by the user, the touch detecting unit 122 also detects a coordinate where the touch event is generated and transmits the detected coordinate to the controller 160. The controller 160 performs a function corresponding to an area where the touch event is generated, by a signal transmitted from the touch detecting unit 122.

The touch detecting unit 122 may be configured to convert a change in a pressure applied to a specific portion of the display unit 121 or a change in an electrostatic capacity generated at a specific portion of the display unit 121 into an electric input signal. The touch detecting unit 122 may be configured to detect a touch pressure as well as a touched position and a touched area. When there is a touch input for the touch detecting unit 122, a signal (or signals) corresponding to the touch input may be transferred to a touch controller (not shown). The touch controller (not shown) may process the signal (or signals), and then transmit corresponding data to the controller 160. The controller 160 may identify which area of the touch screen 120 is touched.

The communication unit 130 supports a wireless communication unit and may be configured as a mobile communication module when the electronic device supports the mobile communication function. To this end, the communication unit 130 may include a Radio Frequency (RF) transmitter for up-converting and amplifying a frequency of a transmitted radio signal and an RF receiver for low noise-amplifying a received radio signal and down-converting a frequency. Further, when the electronic device 100 supports a wireless short-range communication function, such as WiFi communication, Bluetooth® communication, Zigbee® communication, Ultra WideBand (UWB) communication, and Near Field Communication (NFC), the communication unit 130 may include a WiFi communication module, a Bluetooth communication module, a Zigbee communication module, a UWB communication module, and an NFC communication module. Particularly, the communication unit 130 according to an embodiment of the present invention receives guide information from another electronic device or a particular server under a control of the controller 160 or transmits metadata generated when an image is obtained to another electronic device or a particular server under a control of the controller 160.

The storage unit 140 may store image data, voice data, data inputted from the camera module 110, data for processing a calculation, an algorithm required for an operation of the electronic device 100, configuration data, and guide information, and also temporarily store a processing result. The storage unit 140 may include a volatile memory or a non-volatile memory. For example, the volatile memory may include a Static Random Access Memory (SRAM) and a Dynamic Random Access Memory (DRAM), and the non-volatile memory may include a Read Only Memory (ROM), a flash memory, a hard disk, a Secure Digital (SD) memory card, and a multimedia card.

The operation unit 150 may include members for performing various configurations when the user operates the electronic device 100 or performs photographing. For example, the operation unit 150 may include various function buttons, such as a power button, a shutter button, a zoom button and the like. The operation unit 150 may be implemented in any form, such as a button, a keyboard, a touch pad, the touch screen 120, a remote controller or the like if the user can input a control signal therethrough.

The controller 160 may process a signal by a digital calculation. The controller 160 may include a Digital Signal Processor (DSP) which can process a signal by a digital calculation. For example, the DSP may reduce noise of input image data and perform image signal processing to improve picture quality, such as gamma correction, color filter interpolation, color matrix, color enhancement and the like. Further, the DSP may compress image data generated through the image signal processing to generate an image file and reconstruct image data from the generated image file. An image compression format may be a reversible or irreversible format. For example, Joint Photographic Experts Group (JPEG) or JPEG 2000 formats may be appropriate.

The controller 160 may perform a function as a calculation processing unit and a control device by a program and provide instructions of a signal system to components within the electronic device 100. The controller 160 according to an embodiment of the present invention controls the storage unit 140 to store one or more pieces of guide information for photographing an image, by the user, received through the communication unit 130. When a guide function is not executed when the camera module 110 is driven, the controller 160 allows an image to be obtained through the camera module 110 according to a user's control. When the guide function is executed when the camera module 110 is driven, the controller 160 allows one or more pieces of guide information in an image form to be displayed on the touch screen 120. When the user selects one of the one or more pieces of guide information, the controller 160 allows an external background obtained through the camera module 110 to be displayed on the touch screen in a preview screen form according to the selected guide information. At this time, the user may change operation configurations of the camera module 110 such as F-number information, shutter speed information, and focal length information included in the guide information through the preview screen. The controller 160 detects the change in the operation configuration of the camera module 110, such as the F-number information, the shutter speed information, and the focal length information and display the change on the preview screen. The controller 160 controls a lens, an aperture, and a shutter of the camera module 110 according to metadata included in the guide information, for example, the F-number information, the shutter speed information, and the focal length information according to the selected guide information.

The controller 160 according to another embodiment of the present invention controls the storage unit 140 to store one or more pieces of guide information for photographing an image by the user through the communication unit 130. The controller 160 determines whether to execute the guide function when driving the camera module 110. When the guide function is not executed, the controller 160 obtains an image according to a user's control. When the guide function is executed, the controller 160 analyzes the image obtained through the camera module 110. The controller 160 calculates guide information mapped with the analyzed image among the one or more pieces of guide information. The controller 160 obtains an image according to the calculated guide information.

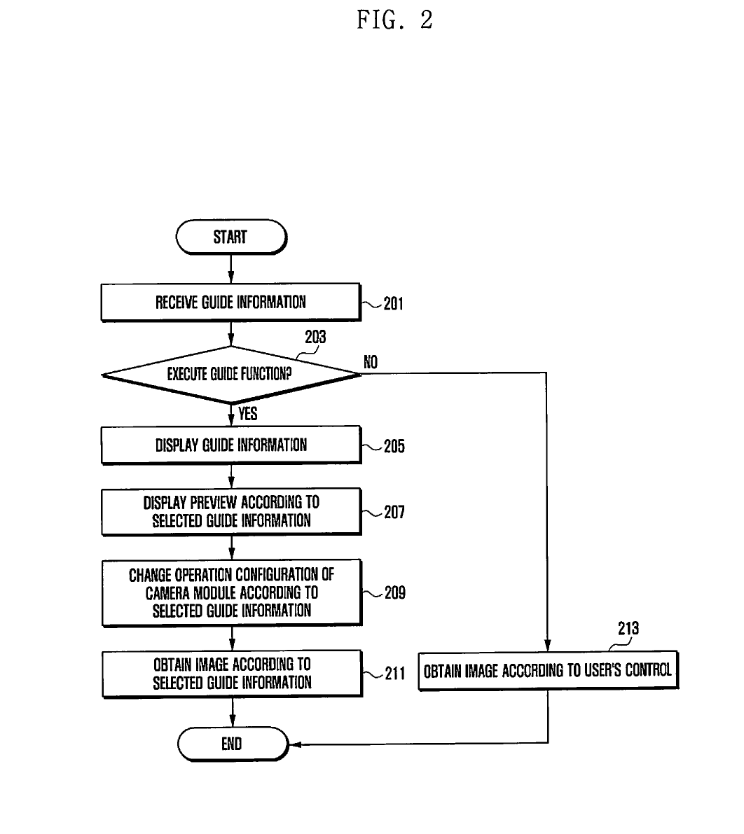

FIG. 2 is a flowchart illustrating an image photographing method of the electronic device 100, according to an embodiment of the present invention.

The electronic device 100 receives one or more pieces of guide information for photographing an image by the user through the communication unit 130. The guide information includes image information and information which can control F-number information, shutter speed information, and focal length information of the camera module 110. For example, the information which can control F-number information, shutter speed information, and focal length information of the camera module 110 may be metadata stored in an image file and may use an Exchangeable image file format (Exif). The Exif is a video file format stored in a digital image file and includes image data and detailed additional information on an image, such as a camera maker, a camera model, an image editor (e.g., software), a data (e.g., date and time) when an image is corrected, an Exif version, a date (e.g., shoot date and time) when an image is photographed, an actual image size, an exposure time (e.g., shutter speed information), an ISO speed, a photographing program (e.g., exposure program), a lens focal length, F-Number information, and whether a flash was used. For example, the exposure time or the shutter speed information relates to shutter speed information of the camera module 110. When the shutter speed information is 125, this corresponds to an exposure time that is 1/125 seconds, and the exposure time decreases as the shutter speed information number increases. The aperture is a circular device through which light passing through a lens is controlled through an adjustment of a size of a hole thereof. The F-number information relates to controlling light incident to the lens. As the F-number information increases, a size of an open hole of a control device mounted to the lens decreases and thus incident light decreases. As the F-number information decreases, the open hole increases and thus incident light increases. The F-number is indicated by f/stop. As the F-number information increases, a depth of field increases (e.g., in focusing). As the F-number information decreases, a depth of field decreases (e.g., out focusing).

The electronic device 100 determines whether to execute the guide function when driving the camera module 110 at step 203. When the guide function is not executed, the electronic device 100 obtains an image through the camera module 110 according to a user's control at step 213. When the guide function is executed, the electronic device 100 displays one or more pieces of guide information in an image form on the touch screen 120 at step 205. The electronic device 100 displays an external background obtained through the camera module 110 on the touch screen 120 through a preview screen according to the guide information selected from the one or more pieces of guide information at step 207. At this time, the user may change operation configurations of the camera module 110, such as F-number information, shutter speed information, and focal length information included in the guide information through the preview screen. The electronic device detects the change in the operation configuration of the camera module 110, such as the F-number information, the shutter speed information, and the focal length information and display the change on the preview screen at step 207.

The electronic device 100 changes the operation configuration of the camera module 110 according to the selected guide information at step 209. A process of changing the operation configuration of the camera module 110 may be a process of controlling a lens, an aperture, and a shutter of the camera module 110 according to metadata included in the guide information, for example, the F-number information, the shutter speed information, and the focal length information. The electronic device 100 obtains an image according to the selected guide information at step 211.

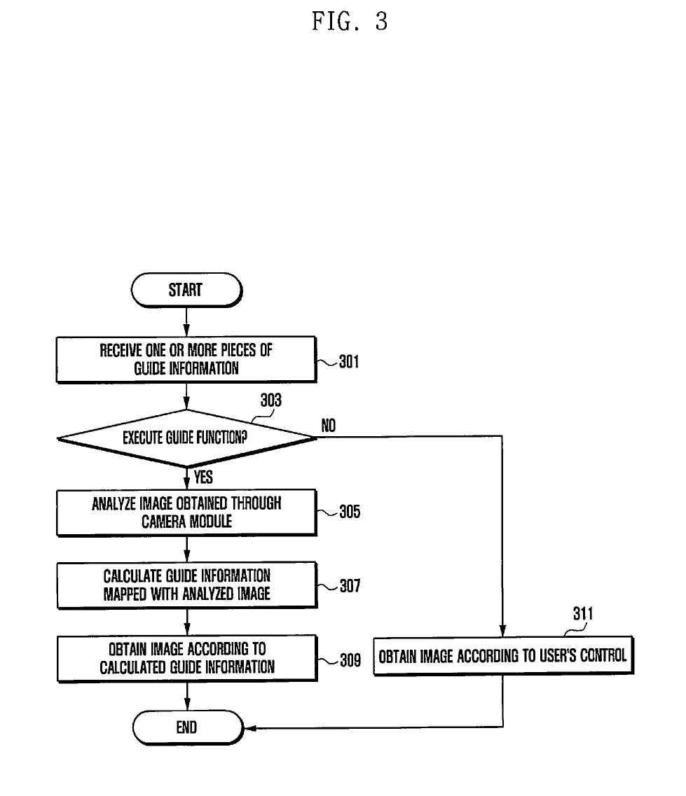

FIG. 3 is a flowchart illustrating an image photographing method of the electronic device 100, according to another embodiment of the present invention.

The electronic device 100 receives one or more pieces of guide information for photographing an image by the user through the communication unit 130 at step 301. The electronic device 100 determines whether to execute the guide function when driving the camera module 110 at step 303. When the guide function is not executed, the electronic device 100 obtains an image according to a user's control at step 311. When the guide function is executed, the electronic device 100 analyzes the image obtained through the camera module 110 at step 305. The electronic device 100 calculates guide information mapped with the analyzed image among the one or more pieces of guide information at step 307. The electronic device 100 obtains an image according to the calculated guide information at step 309.

The electronic device 100 receives guide information in an image form and displays the guide information on the touch screen 120.

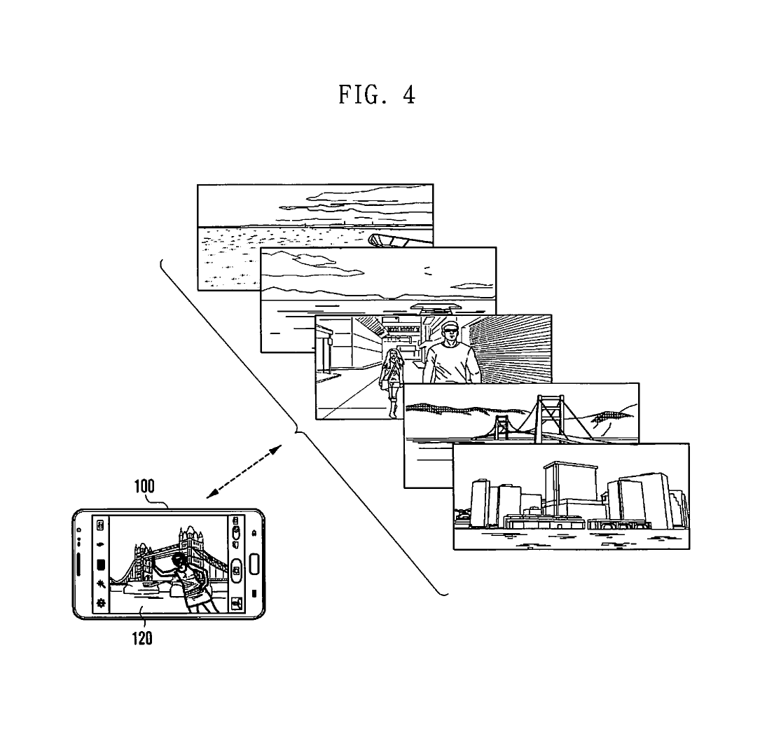

FIG. 4 illustrates an image photographing method of the electronic device 100, according to an embodiment of the present invention. A method in which the electronic device 100 receives guide information in an image form and displays the guide information on the touch screen 120 will be described below. The electronic device 100 receives one or more pieces of guide information through the communication unit 130 and stores the guide information in the storage unit 140. When the guide function is executed when a subject is photographed, the electronic device 200 displays a plurality of pieces of guide information in an image form on the touch screen 120. When the user selects one of the one or more pieces of guide information displayed on the touch screen 120, the electronic device 100 allows an external background obtained through the camera module 110 to be displayed on the touch screen 120 in a form of a preview screen according to the selected guide information.

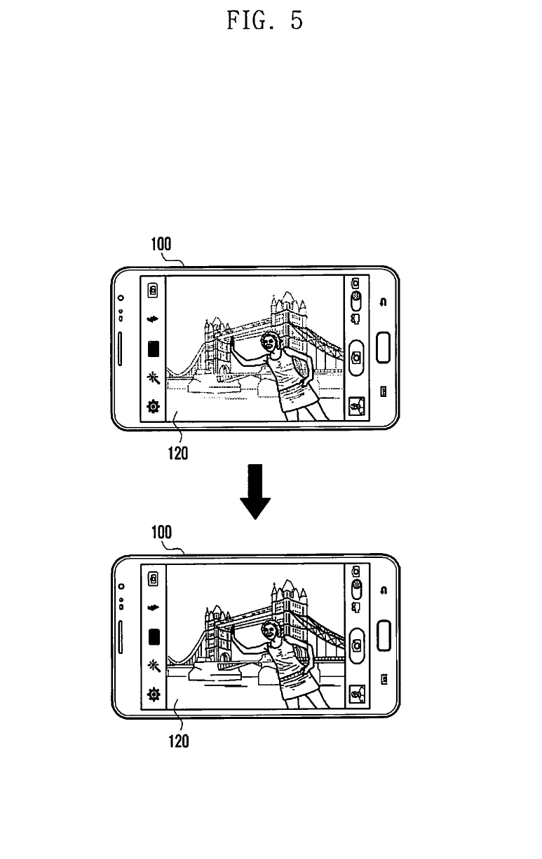

FIG. 5 illustrates an image photographing method using the electronic device 100, according to an embodiment of the present invention.

The electronic device 100 displays an external background obtained through the camera module 110 on the touch screen 120 through a preview screen according to the guide information selected from the one or more pieces of guide information. At this time, the user may change operation configurations of the camera module 110, such as F-number information, shutter speed information, and focal length information included in the guide information through the preview screen. When the user controls the F-number information, the shutter speed information, and the focal length information to be different from the guide information, it may be determined whether the control corresponds to an optimal control and a result thereof may be displayed on the touch screen 120. For example, when the user selects optimal focal length information, the user is informed through a highlight (color, flickering or the like) on the touch screen 120.

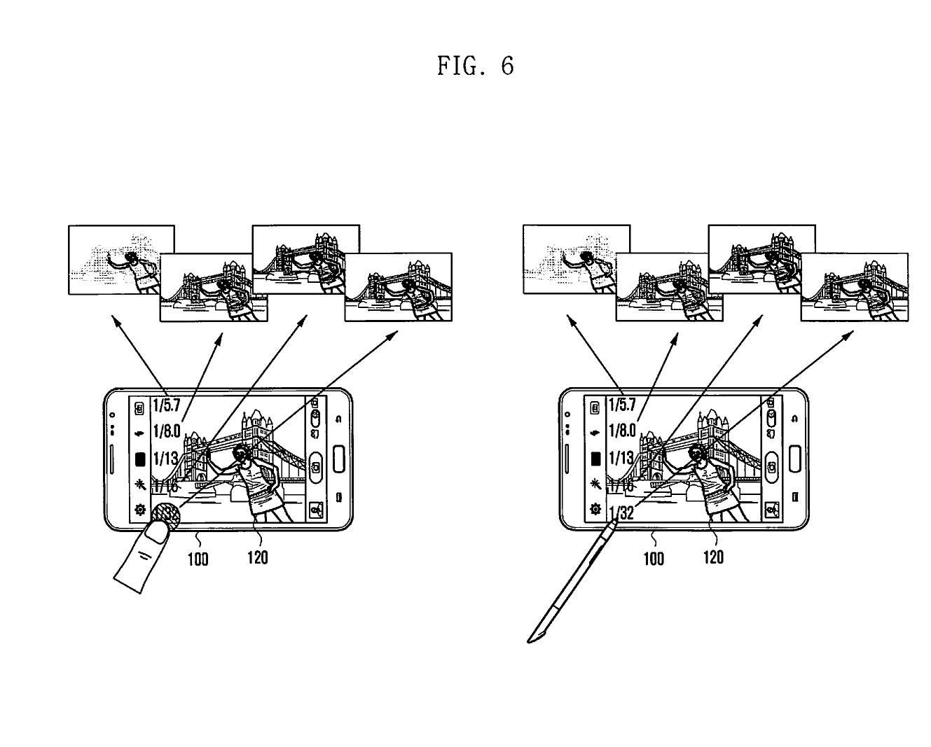

FIG. 6 illustrates an image photographing method using the electronic device 100, according to an embodiment of the present invention.

The electronic device 100 displays an external background obtained through the camera module 110 on the touch screen 120 through a preview screen according to the guide information selected from the one or more pieces of guide information. At this time, the user may change operation configurations of the camera module 110, such as F-number information, shutter speed information, and focal length information included in the guide information through the preview screen. When the user changes the operation configurations of the camera module 110, such as the F-number information, the shutter speed information, and the focal length information, the change can be made through a touch event or a hovering by a touch pen.

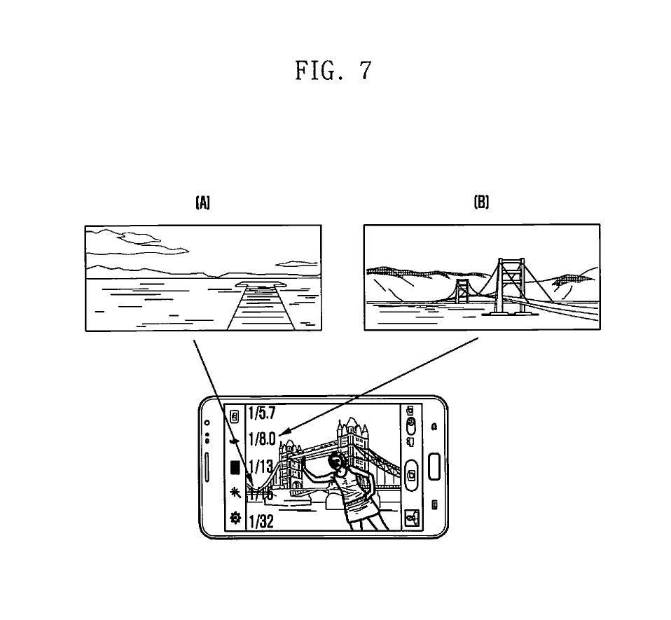

FIG. 7 illustrates an image photographing method using the electronic device 100, according to another embodiment of the present invention.

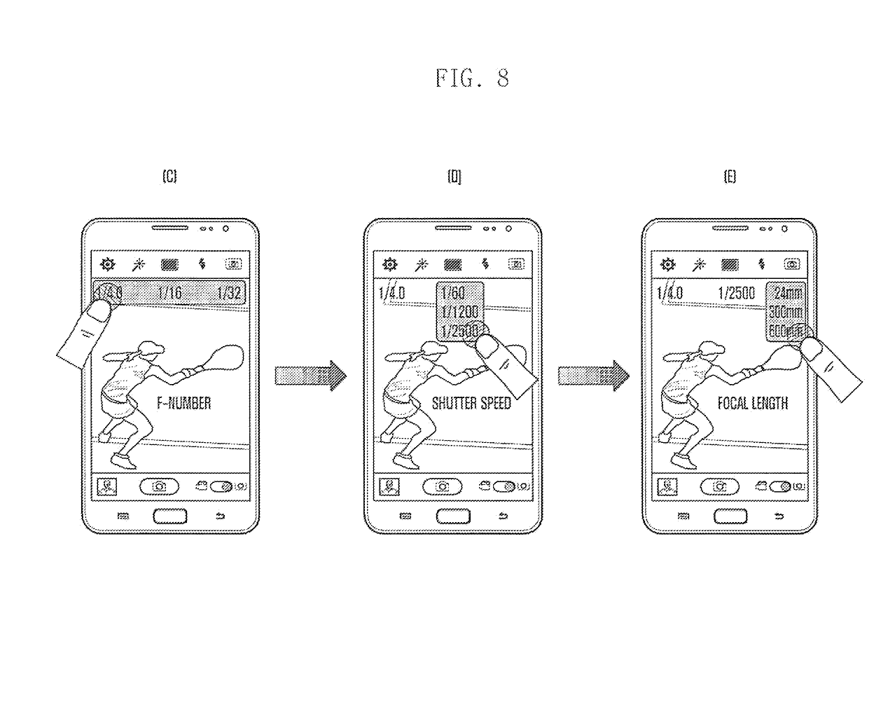

When the guide function is executed, the electronic device 100 analyzes the image obtained through the camera module 110. The electronic device 100 calculates guide information mapped with the analyzed image among one or more pieces of guide information. At this time, the user may change operation configurations of the camera module 110, such as F-number information, shutter speed information, and focal length information included in the guide information. When the user configures the focal length information as f/32 in the analyzed image, guide information according to screen A is calculated and displayed. When the user configures the focal length information as f/8.0 in the analyzed image, guide information according to screen B is calculated and displayed. FIG. 8 illustrates an image photographing method using the electronic device 100, according to another embodiment of the present invention.

When the guide function is executed, the electronic device 100 analyzes the image obtained through the camera module 110. The electronic device 100 calculates guide information mapped with the analyzed image among one or more pieces of guide information. At this time, the user may change operation configurations of the camera module 110, such as F-number information, shutter speed information, and focal length information included in the guide information. When the user changes the F-number information, as illustrated in screen C, the electronic device 100 may provide shutter speed information appropriate for the changed F-number information, as illustrated in screen D, and provide a focal length appropriate for the changed F-number information and shutter speed information, as illustrated in screen E.

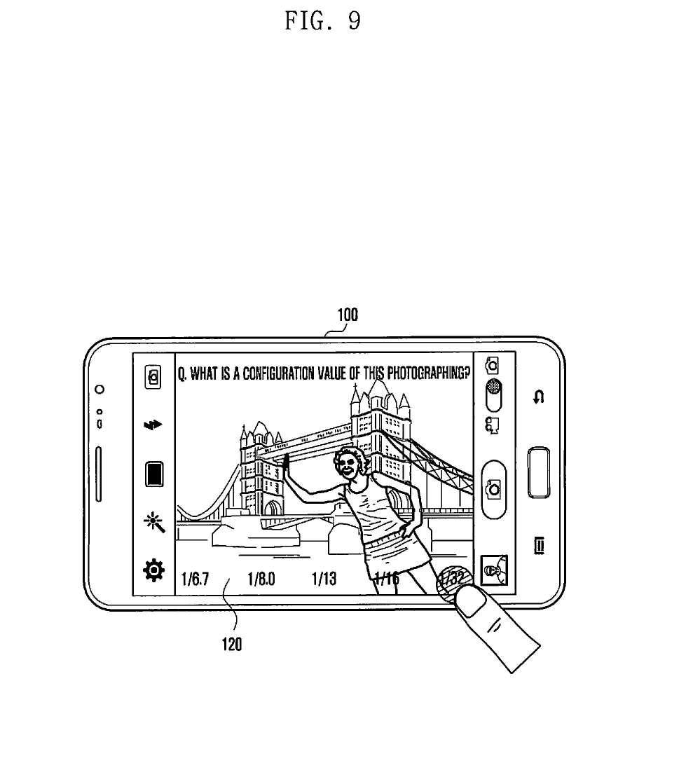

FIG. 9 illustrates an image method for providing function related to photography training using the electronic device 100, according to an embodiment of the present invention. The electronic device 100 allows the user to learn photography by using an obtained image and metadata. When a function related to photography training is selected, the electronic device 100 displays an obtained image on the touch screen 120 and allows the user to select metadata appropriate for the obtained image.

According to an embodiment of the present invention, when a function related to photography training is selected, the electronic device 100 displays at least one of a QUIZ on the touch screen 120 related to the art of taking and processing photographs by using the obtained image and metadata.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method of photographing an image using an electronic device including a camera module, the method comprising:
receiving, at the electronic device, one or more pieces of guide information;
determining whether to execute a guide function when driving the camera module;
displaying the one or more pieces of guide information when the guide function is executed;
displaying an external background obtained through the camera module in a preview screen form according to selected guide information; and
obtaining an image according to the selected guide information.

2. The method of claim 1, further comprising changing an operation configuration of the camera module according to the selected guide information.

3. The method of claim 1, wherein the guide information is obtained through a particular server or another electronic device and includes at least one of a predetermined image and metadata of the predetermined image.

4. The method of claim 3, wherein the metadata includes at least one of F-number information, shutter speed information and focal length information obtained when the predetermined image is photographed.

5. The method of claim 4, wherein displaying the external background obtained through the camera module in the preview screen form comprises changing at least one of the F-number information, the shutter speed information and the focal length information.

6. A method of photographing an image using an electronic device including a camera module, the method comprising:
receiving, at the electronic device, one or more pieces of guide information;
determining whether to execute a guide function when driving the camera module;
analyzing an image obtained through the camera module when the guide function is executed;
calculating guide information mapped with the analyzed image among the one or more pieces of guide information; and
obtaining an image through the camera module according to the calculated guide information.

7. The method of claim 6, further comprising changing an operation configuration of the camera module according to the calculated guide information.

8. The method of claim 7, wherein the guide information is obtained through a particular server or another electronic device and includes at least one of a predetermined image and metadata of the predetermined image.

9. The method of claim 8, wherein the metadata includes at least one of F-number information, shutter speed information and focal length information obtained when the predetermined image is photographed.

10. The method of claim 9, wherein displaying the external background obtained through the camera module in the preview screen form comprises changing at least one of the F-number information, the shutter speed information and the focal length information.

11. An electronic device comprising:
a communication unit configured to transmit/receive one or more pieces of guide information to/from a particular server or anther electronic device;
a storage unit configured to store the received one or more pieces of guide information;
a touch screen configured to display the one or more pieces of guide information and an external background through a preview screen;
a controller configured to determine whether to execute a guide function, to display the one or more pieces of guide information on the touch screen when the guide function is executed, and to display the external background on the touch screen through the preview screen according to selected guide information; and
a camera module configured to obtain an image according to the selected guide information.

12. The electronic device of claim 11, wherein the controller changes an operation configuration of the camera module according to the selected guide information.

13. The electronic device of claim 12, wherein the guide information includes at least one of a predetermined image and metadata of the predetermined image.

14. The electronic device of claim 13, wherein the metadata includes at least one of F-number information, shutter speed information and focal length information obtained when the predetermined image is photographed.

15. The electronic device of claim 14, wherein the controller displays at least one of the F-number information, the shutter speed information and the focal length information through the preview screen.

16. The electronic device of claim 11, wherein, when the guide function is executed, the controller analyzes an image obtained through the camera module, calculates guide information mapped with the analyzed image among the one or more pieces of guide information, and obtains an image through the camera module according to the calculated guide information.

17. The electronic device of claim 16, wherein the controller changes an operation configuration of the camera module according to the selected guide information.

18. The electronic device of claim 17, wherein, when a function related to photography training is selected, the controller controls the touch screen to display at least one of a QUIZ on the touch screen 120 related to the art of taking and processing photographs by using the obtained image and the obtained metadata.
